(19) United States
(12) Patent Application Publication
(10) Pub. No.: US 2026/0089781 A1
(43) Pub. Date: Mar. 26, 2026

(54) DUAL SIM/ESIM SINGLE STANDBY WIRELESS DEVICE

(71) Applicant: Apple Inc., Cupertino, CA (US)

(72) Inventors: Jean-Marc PADOVA, San Francisco, CA (US); Abishek Kumar VAIDYANATHAN, Union City, CA (US); Kanuganti Rajeswar REDDY, Castro Valley, CA (US); Li LI, Los Altos, CA (US); Nithish Kulur PRABHAKARA, Sunnyvale, CA (US); Vidur GUPTA, Atherton, CA (US); Viswanath NAGARAJAN, San Jose, CA (US); Raj S. CHAUGULE, Santa Clara, CA (US)

(21) Appl. No.: 19/279,230

(22) Filed: Jul. 24, 2025

Related U.S. Application Data
(60) Provisional application No. 63/699,498, filed on Sep. 26, 2024.
(60) Provisional application No. 63/704,478, filed on Oct. 7, 2024.

(51) Int. Cl. H04W 76/15; H04L 41/0895; H04L 65/1016; H04L 65/1073; H04L 65/1104; H04W 12/0431; H04W 12/06

(52) U.S. Cl. CPC H04W 76/15; H04L 41/0895; H04L 65/1016; H04L 65/1073; H04L 65/1104; H04W 12/0431; H04W 12/06

(57) ABSTRACT

The described embodiments regard methods and apparatus for configuring a wireless device to allow multiple subscriptions to be active simultaneously with data for at least one subscription associated with a SIM/eSIM in a partially active mode to be communicated via a cellular wireless connection established with another SIM/eSIM in a fully active mode. At least one SIM/eSIM is enabled, active, and registered for cellular wireless service and able to be used for establishing a cellular wireless data connection with a cellular wireless network. At least one additional SIM/eSIM is in a partially active state and can be registered for access to select cellular wireless services via the cellular wireless data connection of the at least one SIM/eSIM, where direct cellular wireless network connections via access network portions of cellular wireless networks cannot be established using the at least one additional SIM/eSIM while in the partially active state.

### CROSS-REFERENCE TO RELATED APPLICATIONS

The present application claims the benefit of U.S. Provisional Application No. 63/704,478, entitled “DUAL SIM/ESIM SINGLE STANDBY WIRELESS DEVICE,” filed Oct. 7, 2024 and claims the benefit of U.S. Provisional Application No. 63/699,498, filed Sep. 26, 2024 of the same title, the contents of all of which are incorporated by reference herein in their entirety for all purposes.

### FIELD

The described embodiments relate to wireless communications, including methods and apparatus for configuring a device that includes multiple subscriber identity modules (SIMs) and/or electronic SIMs (eSIMs) and has limited hardware resources for independent communication with multiple SIMs/eSIMs simultaneously to allow a cellular wireless connection of a first SIM/eSIM to support communication for additional SIMs/eSIMs.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A multi-SIM/eSIM wireless device can include multiple SIMs and/or eSIMs that each are associated with a cellular wireless subscription. The multi-SIM/eSIM wireless device, due to hardware limitations, may be limited in the number of SIMs/eSIMs that can be used at any given time. A user of the multi-SIM/eSIM wireless device can seek to mirror a cellular wireless configuration of an associated wireless device, such as to have subscriptions of multiple SIMs/eSIMs accessible simultaneously. There is a need to provide access to multiple cellular wireless subscriptions by a wireless device with limited hardware resources.

### SUMMARY

The described embodiments relate to wireless communications, including methods and apparatus for configuring a wireless device to allow multiple subscriptions to be active simultaneously with data for at least one subscription associated with a SIM/eSIM in a partially active mode to be communicated via a cellular wireless connection established with another SIM/eSIM in a fully active mode. A first SIM/eSIM for a first subscription can be enabled, active, and registered to allow the wireless device access to cellular wireless services of a cellular wireless network. A second SIM/eSIM for a second subscription (or more generally multiple SIMs/eSIMs for additional subscriptions) can be partially enabled for access to select files and/or services of the second SIM/eSIM. The second SIM/eSIM can be accessible for communication by a processor to interact with files and service processes but remain in a disabled state where the second SIM/eSIM is not actively connected to or used to establish a cellular wireless connection directly with an associated cellular wireless network. The first SIM/eSIM can be used to establish cellular connectivity directly with a cellular wireless network, and communication for the second SIM/eSIM can be tunneled through a data connection of the first SIM/eSIM. The wireless device can establish a data connection via the first SIM/eSIM directly with a cellular wireless network and register the second SIM/eSIM, via the data connection of the first SIM/eSIM, with a session initiation protocol (SIP) internet protocol multimedia subsystem (IMS) service for access to packet switched services of the cellular wireless network associated with the second SIM/eSIM. Traffic associated with the second SIM/eSIM, such as short message service (SMS) traffic or “voice over IP” traffic for the second SIM/eSIM can be routed via the cellular data connection of the first SIM/eSIM, e.g., tunneled via a connection between a packet data network (PDN) gateway of the cellular wireless network associated with the first SIM/eSIM and an evolved PDN gateway (ePDG) of the cellular wireless network associated with the second SIM/eSIM. IMS registration for the second SIM/eSIM can be performed using authentication data obtained from the second SIM/eSIM while in the disabled (for cellular service) but partially active (for access to files and/or processes) mode, e.g., data and/or messages for an extensible authentication protocol-authentication and key agreement (EAP-AKA) procedure can be obtained from the second SIM/eSIM without enabling the second SIM/eSIM for active service via a direct cellular connection.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a mobile wireless device of the system of FIG. 1, according to some embodiments.

FIG. 3A illustrates a block diagram of an exemplary dual SIM wireless device in communication with two different wireless networks, according to some embodiments.

FIG. 3B illustrates block diagrams of exemplary multi-SIM and multi-SIM/eSIM wireless devices, according to some embodiments.

FIG. 4 illustrates a block diagram of a multi-SIM/eSIM wireless device in communication with a second cellular wireless network via a first cellular wireless network, according to some embodiments.

FIG. 5A illustrates a block diagram of a cellular capable secondary wireless device communicating using a wireless wide area network relayed connection via a primary wireless device, according to some embodiments.

FIG. 5B illustrates a block diagram of a cellular capable secondary wireless device communicating using a wireless wide area network direct connection, according to some embodiments.

FIGS. 6A and 6B illustrate flow diagrams of a dual-eSIM wireless device with dual fully active capability, according to some embodiments.

FIGS. 7A and 7B illustrate flow diagrams of a dual-eSIM wireless device with a single fully active, single partially active capability, according to some embodiments.

FIG. 8 illustrates a diagram for a multiple-eSIM wireless device with a dual fully active, dual partially active capability, according to some embodiments.

FIG. 9A illustrates a flow chart of an exemplary method to enable virtual connectivity for a second eSIM via a cellular wireless capability of a first eSIM of a wireless device, according to some embodiments.

FIG. 9B illustrates a flow chart of an exemplary method to enable virtual connectivity for one or more secondary eSIMs via cellular wireless capabilities of one or more primary eSIMs of a wireless device, according to some embodiments.

FIG. 10 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

Some single-standby wireless device can store more than one SIM/eSIM at a time; however, without a multiple-standby capability, only one of the SIMs/eSIMs of the single-standby wireless device is usable at any given time. A cellular capable secondary wireless device, such as a smart watch, can be associated with a primary wireless device, such as a smart phone, where the primary wireless device supports use of multiple SIMs/eSIMs in a multiple-standby mode at the same time. The cellular capable secondary wireless device with only a single-standby capability, however, can be unable to mirror the multiple-standby capability of the associated primary wireless device. When the cellular capable secondary wireless device is communicatively coupled with the primary wireless device via a local wireless connection, the cellular capable secondary wireless device can be able to communicate via multiple SIMs/eSIMs of the primary wireless device; however, when separated from the primary wireless device, the cellular capable secondary wireless device with a single-standby capability can be restricted to use of a single SIM/eSIM, which may require explicit selection of a particular subscription of the subscriptions of the multiple SIMs/eSIMs, while non-selected subscriptions can be inaccessible by the cellular capable secondary wireless device while separated from the primary wireless device.

Without requiring changes to add a multiple-standby hardware capability to the cellular capable secondary wireless device, a software configuration can be used to allow multiple subscriptions to be active simultaneously on a single-standby wireless device. A first SIM/eSIM for a first subscription can be enabled, active, and registered to allow the single-standby wireless device access to cellular wireless services of a cellular wireless network. A second SIM/eSIM for a second subscription (or more generally multiple SIMs/eSIMs for additional subscriptions) can be partially enabled for access to select files and/or services of the second SIM/eSIM. The second SIM/eSIM can be accessible for communication by a processor to interact with files and service processes but remain in a disabled state where the second SIM/eSIM is not actively connected to or used to establish a cellular wireless connection directly with an associated cellular wireless network. In some embodiments, the second SIM/eSIM can be referred to being partially enabled or partially active, however the second SIM/eSIM is not active directly on the cellular wireless network. The first SIM/eSIM can be used to establish cellular connectivity directly with a cellular wireless network, and communication for the second SIM/eSIM can be tunneled through a data connection of the first SIM/eSIM. The single-standby wireless device can establish a data connection via the first SIM/eSIM directly with a cellular wireless network and register the second SIM/eSIM, via the data connection of the first SIM/eSIM, with a session initiation protocol (SIP) internet protocol multimedia subsystem (IMS) service for access to packet switched services of the cellular wireless network associated with the second SIM/eSIM. Traffic associated with the second SIM/eSIM-, such as short message service (SMS) traffic or “voice over IP” traffic for the second SIM/eSIM can be routed via the cellular data connection of the first SIM/eSIM, e.g., tunneled via a connection between a packet data network (PDN) gateway of the cellular wireless network associated with the first SIM/eSIM and an evolved PDN gateway (ePDG) of the cellular wireless network associated with the second SIM/eSIM. IMS registration for the second SIM/eSIM can be performed using authentication data obtained from the second SIM/eSIM while in the disabled (for cellular service) but partially active (for access to files and/or processes) state, e.g., data and/or messages for an extensible authentication protocol-authentication and key agreement (EAP-AKA) procedure can be obtained from the second SIM/eSIM without enabling the second SIM/eSIM for active service via a direct cellular connection. By using the disabled, partially active state of SIMs/eSIMs in parallel with an enabled, active SIM/eSIM, the single-standby wireless device can communicate via the additional SIMs/eSIMs using tunneled connections via the active SIM/eSIM. In some embodiments, a dual-standby wireless device with two active SIMs/eSIMs can be configured to tunnel additional SIMs/eSIMs via one or more of the two active SIMs/eSIMs. In some embodiments, a limited functionality eSIM, such as a bootstrap eSIM used for initialization of a wireless device, can be used to provide cellular connectivity when cellular service via a primary SIM/eSIM is unavailable, e.g., in an out-of-service range of the cellular wireless network associated with the primary SIM/eSIM or while roaming. A cellular connection by the limited functionality eSIM can be used to carry tunneled voice over IP (VOIP) and/or SMS traffic for the primary SIM/eSIM when in an out-of-service condition or while roaming away from the cellular wireless network associated with the primary SIM/eSIM. In some embodiments, a local data SIM/eSIM can be used on the wireless device to establish local cellular data connectivity and a tunneled data connection to the cellular wireless network of a primary SIM/eSIM of the wireless device can be established to allow the wireless device to send and receive VoIP callas and/or SMS messages for the primary SIM/eSIM via the tunneled data connection through the local data SIM/eSIM.

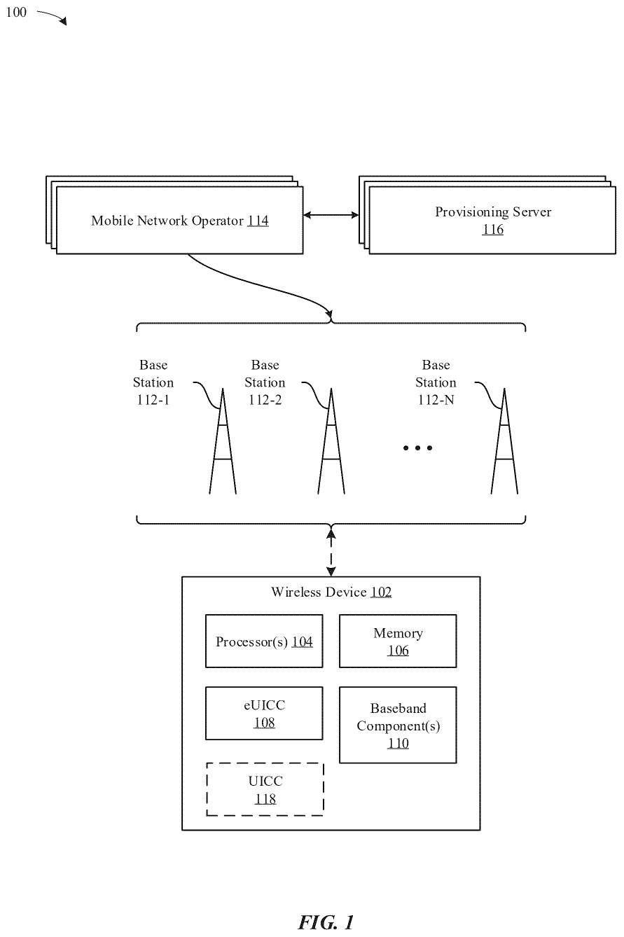

These and other embodiments are discussed below with reference to FIGS. 1 through 10; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver. In some embodiments, the wireless device 102 is configured to operate in a dual SIM/eSIM, single standby mode, with one SIM/eSIM enabled and one SIM/eSIM disabled (or partially enabled) where communication for the disabled (partially enabled) SIM/eSIM is transported at least in part by a cellular connection of the enabled SIM/eSIM. In some embodiments, the wireless device 102 includes two or more transceivers. In some embodiments, the wireless device 102 can be configured to operate in a dual SIM, dual standby (DSDS) mode, with two SIMs, one SIM and one eSIM, or two eSIMs enabled and active simultaneously, but allowing active connections to only one cellular wireless network via a single, active transceiver at a time. In some embodiments, the transceiver of the wireless device 102 includes multiple receivers to allow reception of signals from multiple wireless networks and only one transmitter for transmitting signals to one of the multiple wireless networks at a time. In some embodiments, the wireless device 102 includes hardware that is restricted to a dual SIM/eSIM single standby capability and software and/or firmware that allows the wireless device 102 to emulate a DSDS capability, i.e., to provide a virtual DSDS capability, via an enabled/active SIM/eSIM that carries data packets for packet voice (e.g., voice over IP) and packet messaging (e.g., SMS) for a disabled/partially active SIM/eSIM. In some embodiments, the wireless device 102 includes a limited functionality bootstrap SIM/eSIM that can be used to maintain connectivity for a home network SIM/eSIM when the wireless device 102 is out of range of a home cellular wireless network, e.g., in an out of service condition, or when the wireless device 102 is roaming on a visited (non-home) cellular wireless network. The wireless device 102 can be configured to initiate and receive packet voice calls and to send and receive SMS data for a second SIM/eSIM via a tunneled connection via a first SIM/eSIM to an evolved packet data network gateway (ePDG) of a cellular wireless network associated with the second SIM/eSIM. The wireless device 102 can use a cellular data connection of the first SIM/eSIM to register the second SIM/eSIM with a session initiation protocol (SIP) internet protocol multimedia subsystem (IMS) service for access to packet switched services of the cellular wireless network associated with the second SIM/eSIM.

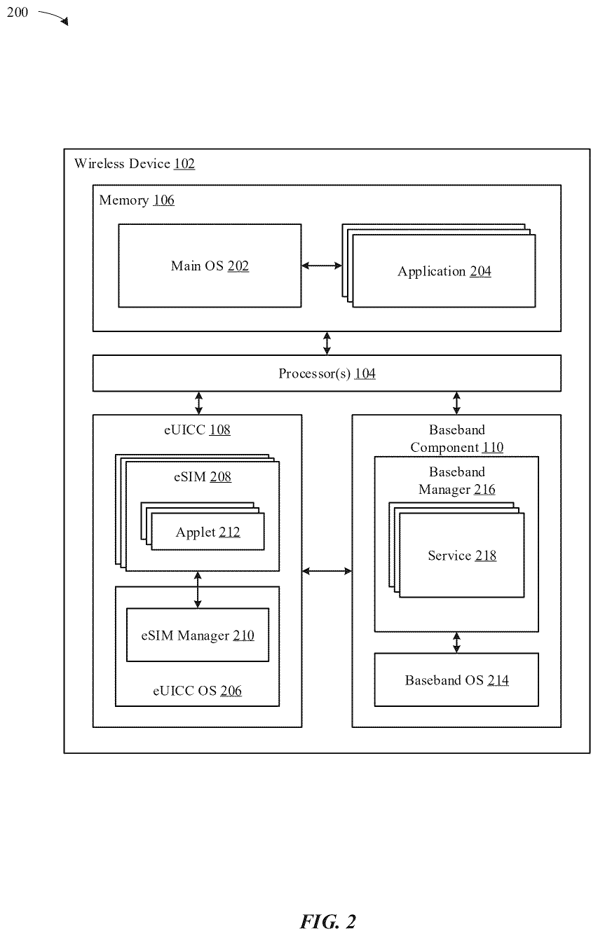

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

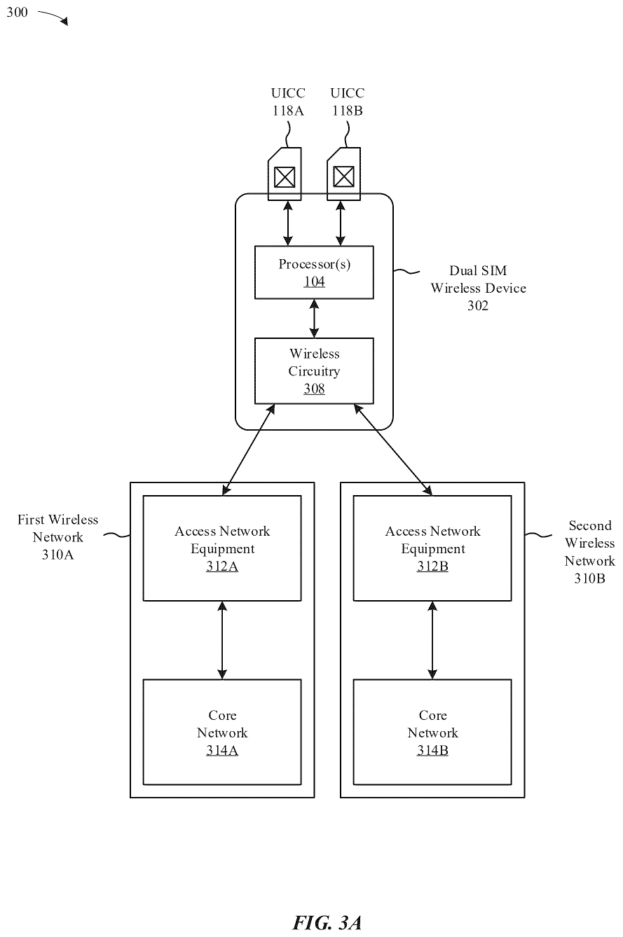

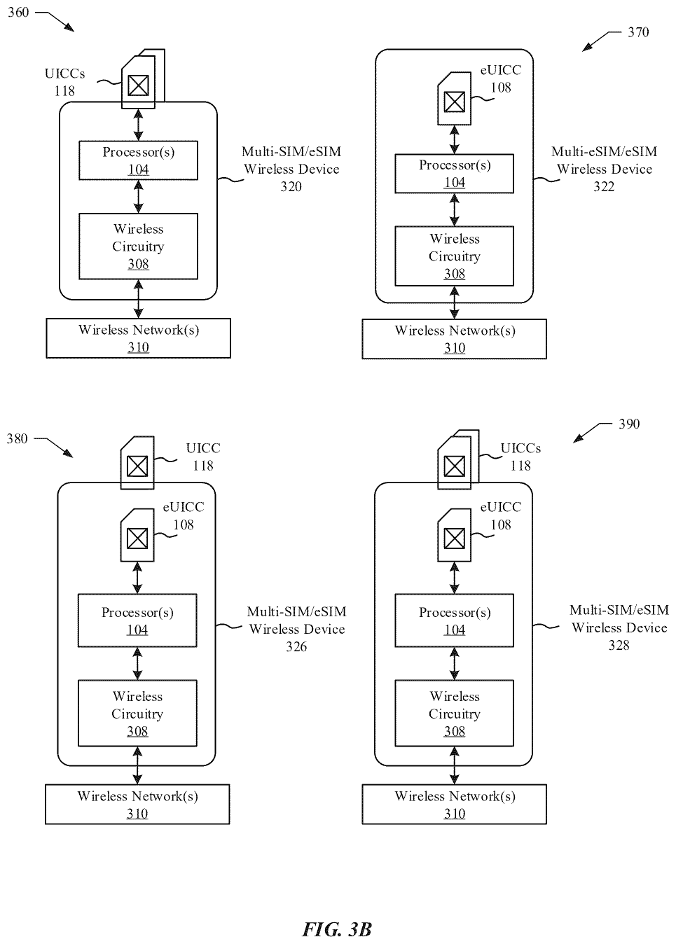

FIG. 3A illustrates a block diagram 300 of components of an exemplary dual SIM wireless device 302 including one or more processor(s) 104 and wireless circuitry 308 that provides for wireless radio frequency (RF) connections between the dual SIM wireless device 302 and a first wireless network 310A and a second wireless network 310B. In some embodiments, the wireless circuitry 308 can include the baseband component 110, and a set of RF analog front-end circuitry. In some embodiments, the wireless circuitry 308 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 308 can include components of RF analog front-end circuitry, e.g., a set of one or more antennas, which can be interconnected with additional supporting RF circuitry that can include filters and other analog components that can be “configured” for transmission and/or reception of analog signals via one or more corresponding antennas to one or more of the first and second wireless networks 310A/B. The processor(s) 104 and the wireless circuitry 308 can be configured to perform and/or control performance of one or more functionalities of the dual SIM wireless device 302, in accordance with various implementations. The processor(s) 104 and the wireless circuitry 308 can provide functionality for coordinating hardware/software resources in the dual SIM wireless device 302 to improve performance for mobility management of connections to one or more of the wireless networks 310A/B.

The dual SIM wireless device 302 includes two removable UICCs 118A/B, which can be inserted and removed from the dual SIM wireless device 302 together or independently. Each UICC 118A/B includes at least one software identity module (SIM), which can be embodied as a software/firmware program installed on the UICC 118A/B. Removable UICCs 118A/B can provide a user of the dual SIM wireless device 302 the ability to replace a UICC to change services, provided the dual SIM wireless device 302 supports such flexibility (e.g., an “unlocked” device that is not “locked” to a particular wireless network operator or service provider). Hardware complexity and/or a size of a wireless device can limit the ability to include multiple UICC slots, and thus additional arrangements for wireless devices can include multiple SIMs on a single UICC 118 and/or eSIMs 208 on an eUICC 108 or combinations thereof. The dual SIM wireless device 302, in some embodiments, can register with two different wireless networks, e.g., the first and second wireless networks 310A/B, simultaneously. The first wireless network 310A can operate in accordance with a first wireless communication protocol, e.g., a 5G NR wireless communication protocol, while the second wireless network 310B can operate with a second wireless communication protocol that can be the same as the first wireless communication protocol or a different wireless communication protocol, e.g., a 4G LTE wireless communication protocol. The first and second wireless networks 310A/B can operate using different radio frequency bands in accordance with their respective wireless communication protocols. The first and second wireless network 310A/B can operate using different radio frequency bands of a common wireless communication protocol, e.g., using an FR1 RF band and an FR2 band of a 5G NR wireless communication protocol. The wireless circuitry 308 of the dual SIM wireless device 302 can be configured to register with and/or establish a connection with the first wireless network 310A via access network equipment 312A, which interfaces with a core network 314A. The wireless circuitry 308 of the dual SIM wireless device 302 can also be configured to register with and/or establish a connection with the second wireless network 310B via access network equipment 312B, which interfaces with a core network 314B. In some embodiments, the wireless circuitry 308 of the dual SIM wireless device 302 supports transmission and reception to only one of the first and second wireless networks 310A/B at a time. In some embodiments, the wireless circuitry 308 of the dual SIM wireless device 302 supports transmission to only one of the first and second wireless networks 310A/B at a time and reception from one or both of the first and second wireless networks 310A/B. A dual SIM wireless device 302 that can connect to only one wireless network at a time, but can monitor and/or receive communication from two wireless networks with which it is registered, can be referred to as a “Dual SIM, Dual Standby” (DSDS) wireless device. A dual SIM wireless device 302 that can connect to two wireless networks simultaneously using two different subscriber identities can be referred to as a “Dual SIM, Dual Active” (DSDA) wireless device.

In some embodiments, a dual SIM wireless device 302 (or a dual eSIM 208 wireless device, or a wireless device 102 with a UICC 118 and an eSIM 208 on an eUICC 108) can connect via the wireless circuitry 308 to either the first wireless network 310A or to the second wireless network 310B via a cellular wireless connection through an access network of the respective cellular wireless network at any one time. In some embodiments, a wireless device 102, e.g., a dual SIM wireless device 302 (or dual eSIM, or SIM+eSIM wireless device) can be required to select which subscription associated with one of the SIMs/eSIMs is active at any one time and the other subscription associated with another of the SIMs/eSIMs can be in an inactive state. As discussed further herein, software and/or firmware of the wireless device 102 can be configured to allow the cellular wireless connection of a first SIM/eSIM to carry data for a second SIM/eSIM to allow for subscriptions both the first SIM/eSIM and the second SIM/eSIM to be active at the same time. In some embodiments, the first SIM/eSIM is in an enabled/active state, while the second SIM/eSIM is in a disabled/partially active state. For the perspective of a user of the wireless device 102 both subscriptions associated with distinct SIMs/eSIMs are available, while a cellular wireless connection for only one SIM/eSIM is used to carry data for both SIMs/eSIMs.

FIG. 3B illustrates diagrams 360, 370, 380, 390 of additional exemplary multi-SIM/eSIM wireless devices 320, 322, 326, 328 that support multiple subscriptions using removable UICCs 118 and/or eUICCs 108 with SIMs or eSIMs 208 implemented respectively thereon. As illustrated in diagram 360, a multi-SIM/eSIM wireless device 320 includes multiple UICCs 118, which can be inserted and removed individually or together, and communicate with one or more processors 104 that connect to wireless circuitry 308 that provides for wireless communication with one or more wireless networks 310. As the physical size and design of the multi-SIM/eSIM wireless device 320 can limit the number of UICCs 118 that can be supported, alternatively as shown by diagram 370, a multi-SIM/eSIM wireless device 322 can include an eUICC 108 connected with the processor(s) 104 and to the wireless network(s) 310 via the wireless circuitry 308. The eUICC 108 can be built into the multi-SIM/eSIM wireless device 322 and can be not removable from the multi-SIM/eSIM wireless device 322, e.g., permanently affixed to a circuit board in the multi-SIM/eSIM wireless device 322. The eUICC 108 can be programmed such that one or more eSIMs 208 can be implemented on the eUICC 108. Each eSIM 208 can be associated with a distinct subscriber identity and/or provide distinct services or subscriptions for a user of the multi-SIM/eSIM wireless device 322. Diagram 380 illustrates a multi-eSIM/SIM wireless device 326 that includes a removable UICC 118, on which can be installed one or more SIMs, and an eUICC 108 on which one or more eSIMs 208 can be installed. The combination of SIMs on the UICC 118 and/or eSIMs 208 on the eUICC 108 can provide for connections to one or more wireless networks 310 using the wireless circuitry 308 under the control of the processor(s) 104 of the multi-SIM/eSIM wireless device 326. Diagram 390 illustrates another multi-eSIM/SIM wireless device 328 that includes multiple UICCs 118, on which one or more SIMs can be installed, and an eUICC 108, on which one or more eSIMs 208 can be installed. A combination of one or more SIMs on a UICC 118 and/or eSIMs on an eUICC 108 can provide for connections to one or more wireless networks 310 using the wireless circuitry 308 under the control of the processor(s) 104 of the multi-SIM/eSIM wireless device 328. In general, a wireless device 102 that supports multiple subscriber identities can include (i) at an eUICC 108 and/or (ii) one or more UICCs 118. Each UICC 118 can support one or more SIMs, and each eUICC 108 can support one or more eSIMs 208. A wireless device 102 that supports multiple subscriber identities, e.g., 302, 320, 322, 326, 328, can include a combination of SIMs and/or eSIMs 208 to support communication with one or more wireless networks 310.

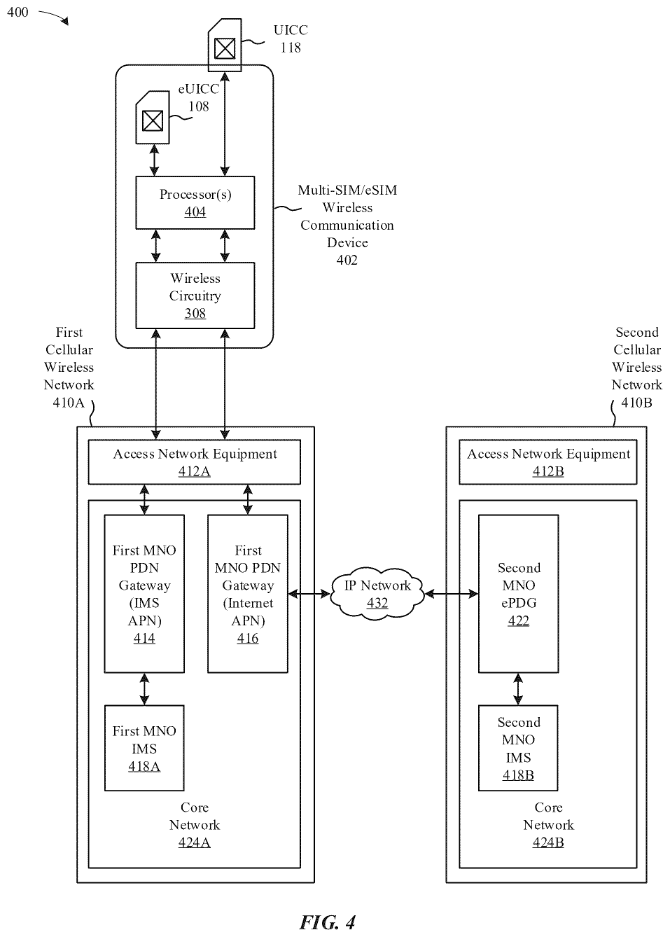

FIG. 4 illustrates a diagram 400 of a multi-SIM/eSIM wireless device 402 that can access services for multiple subscriber identities through a radio access link to access network equipment 412A of a first cellular wireless network 410A. The multi-SIM/eSIM wireless device 402 includes an eUICC 108, on which a first eSIM 208 is installed and provides access to services of the first cellular wireless network 410A, and a UICC 118 on which a SIM, which will be referred to as a second SIM, is installed that provides access to services of a second cellular wireless network 410B. The use of a SIM on a UICC 118 and an eSIM 208 on an eUICC 108 is not intended to be limiting. The same principles to access multiple services described herein for the multi-SIM/eSIM wireless device 402 can apply to any form of multi-SIM/eSIM wireless device (e.g., multi-SIM/eSIM wireless devices 320, 322, 326, 328) that includes multiple SIMs on multiple UICCs 118, multiple eSIMs 208 on an eUICC 108, or a combination of SIMs and eSIMs 208 on one or more UICCs 118 and an eUICC 108 respectively. One or more processors 404 (which can include processors 104 and/or baseband components 110) of the multi-SIM/eSIM wireless device 402 interact with wireless circuitry 308 to establish connections through the access network equipment 412A of the first cellular wireless network 410A. Initially, the multi-SIM/eSIM wireless device 402 can attach to the first cellular wireless network 410A. In some embodiments, the core network 424A of the first cellular wireless network 410A includes a first MNO IMS server 418A with which the multi-SIM/eSIM wireless device 402 registers for services of the first cellular wireless network 410A. The first MNO IMS server 418A is reachable by the multi-SIM/eSIM wireless device 402 via a first MNO PDN gateway 414, e.g., using an IMS access point name (APN) known to the one or more processors 404 of the multi-SIM/eSIM wireless device 402. The multi-SIM/eSIM wireless device 402 can establish a context for data connections, e.g., a packet data protocol (PDP) context, via the access network equipment 412A to a first MNO PDN gateway 416, e.g., using an Internet APN known to the one or more processors 404 of the multi-SIM/eSIM wireless device 402, to connect with the IP network 432. Through a data connection that traverses the access network equipment 412A of the first cellular wireless network 410A and the first MNO PDN gateway 416, the multi-SIM/eSIM wireless device 402 can reach a second MNO IMS server 418B via a second MNO ePDG 422 in the core network 424B of the second cellular wireless network 410B using a tunneled connection over the IP network 432. The multi-SIM/eSIM wireless device 402 can register for access to services of the core network 424B of the second cellular wireless network 410B and need not establish a direct connection with or attach to the second cellular wireless network 410B via the access network equipment 412B of the second cellular wireless network 410B. The multi-SIM/eSIM wireless device 402 can originate voice connections (e.g., voice over IP) or text messaging (e.g., SMS) and/or receive voice connections or text messaging using services of the second cellular wireless network 410B through the data connection established with the first cellular wireless network 410A via the access network equipment 412A. With the multi-SIM/eSIM wireless device 402 attached to the first cellular wireless network 410A (and therefore registered for services with the first cellular wireless network 410A) and also registered in parallel with the second MNO IMS server 418B of the second cellular wireless network 410B (via a data connection through the first cellular wireless network 410A), the multi-SIM/eSIM wireless device 402 can access services of both the first cellular wireless network 410A and the second cellular wireless network 410B simultaneously, e.g., with two different mobile numbers.

While the multi-SIM/eSIM wireless device 402 illustrated in FIG. 4 depicts a single UICC 118 and a single eUICC 108, the same methods can be applied to any combination of UICCs 118 and/or eUICCs 108 of a wireless device 102, such as the various wireless devices 320, 322, 326, 328 illustrated in FIG. 3B. In some embodiments, the multi-SIM/eSIM wireless device 402 can access two different sets of services provided by two different cellular wireless networks 410A, 410B. For example, a single eUICC 108 can include two different eSIMs 208 provided by two different wireless service providers for access to two different cellular wireless networks 410A, 410B. One of the eSIMs 208 can be used for access to a first cellular wireless network 410A including a data connection over which access to services of the second cellular wireless network 410B can be achieved when the core network 424B of the second cellular wireless network 410B includes an IMS server 418B for registering for service. A data connection through the first cellular wireless network 410A to the second cellular wireless network 410B allows for access to services of the second cellular wireless network 410B without establishing a connection through access network equipment 412B of a radio access network of the second cellular wireless network 410B.

An exemplary wireless device 102 that can benefit from the methods described herein include a cellular capable accessory device, e.g., a smart watch, with limited cellular hardware capability for direct cellular wireless connections to cellular wireless networks. For example, a cellular capable wireless device 102 can be associated with another wireless device 102 that includes multiple SIMs/eSIMs for multiple subscriptions, and the cellular capable wireless device 102 cannot include sufficient cellular wireless hardware to allow for the same types of parallel cellular wireless connections as the associated wireless device 102. As described herein, the cellular capable wireless device 102 can be reconfigured with software and/or firmware to emulate a dual SIM/eSIM dual standby capability (or more generally a multi-SIM/eSIM multiple standby capability) without requiring a hardware upgrade.

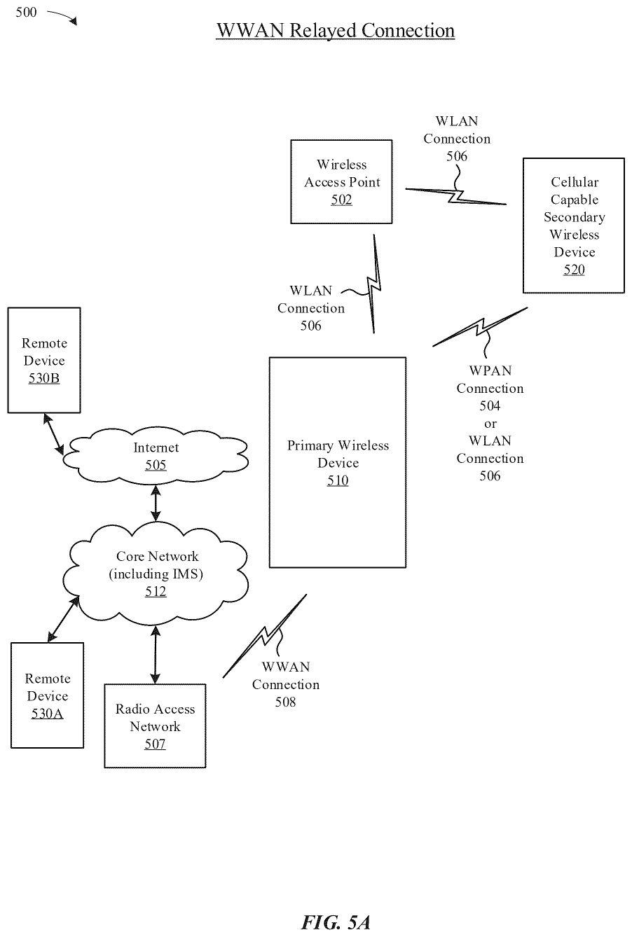

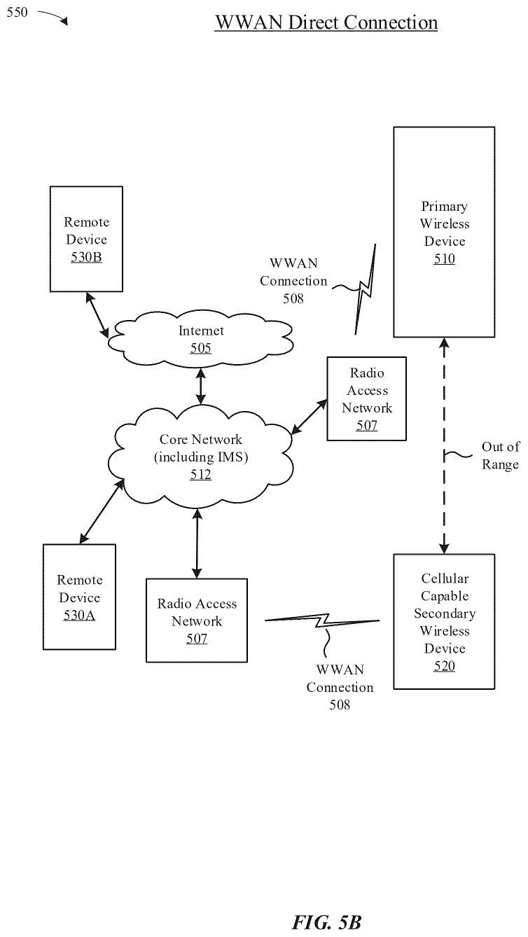

FIG. 5A illustrates a block diagram 500 of a relayed wireless wide area network (WWAN) connection 508, e.g., a cellular wireless connection, between a cellular capable secondary wireless device 520 and a remote device 530A or 530B through a primary wireless device 510 via a local non-cellular wireless network, e.g., via a WLAN connection 506 through wireless AP 502, via a WPAN connection 504, or via a direct WLAN connection 506 between the primary wireless device 510 and the cellular capable secondary wireless device 520. The relayed connection includes a WWAN connection 508 between the primary wireless device 510 and a cellular wireless network that includes a radio access network 507 and a core network 512 (including a SIP IMS service) connected to the Internet 505. Communication via WWAN relayed connections by the cellular capable secondary wireless device 520 can be realized via an LTE wireless network, a 5G NR wireless network, a 6G wireless network, etc. The primary wireless device 510 can serve as an anchor for a connection to a remote device 530A or 530B and relay audio, video, data, messaging, media, or other applicable communication packets to the cellular capable secondary wireless device 520. The relayed connection can use either the WLAN connection 506 (via wireless AP 502 or directly) or the WPAN connection 504 to extend the connection between the primary wireless device 510 and the remote device 530A or 530B to the cellular capable secondary wireless device 520. The WPAN connection 504 can provide limited range, while the WLAN connections 506, either through the wireless access point (AP) 502 or directly, can provide a wider range (as well as higher throughput) for local connection between the primary wireless device 510 and the cellular capable secondary wireless device 520. Communication to and from remote device 530A or 530B can traverse a core network 512, which can include network elements for an IMS service, and in some cases also traverse the Internet 505. Packets for a communication session can be managed by the IMS service and/or by a network-based server knowledgeable of associations between the primary wireless device 510 with the cellular capable secondary wireless device 520, e.g., by a cloud service server. Relayed connections via the primary wireless device 510 can be preferred to direct cellular wireless connections to the cellular capable secondary wireless device 520 when relayed connections are available, as the shorter distance for local communication between the cellular capable secondary wireless device 520 and the primary wireless device 510 can consume less battery power than longer distance direct cellular wireless connections. With WWAN relayed connections, the cellular capable secondary wireless device 520 can mirror a configuration of the primary wireless device 510 with subscriptions for multiple SIMs/eSIMs of the primary wireless device 510 available at the same time.

FIG. 5B illustrates a block diagram 550 of a direct WWAN connection 508 between a cellular capable secondary wireless device 520 and a remote device 530A or 530B, where the direct WWAN connection 508 may be used when the cellular capable secondary wireless device 520 is out of range of the primary wireless device 510 and the cellular wireless network allows the cellular capable secondary wireless device 520 to camp on, attach to, and/or establish a direct cellular connection with the cellular wireless network. The direct WWAN connection 508 for the cellular capable secondary wireless device 520 can provide for packet-switched voice services, such as Voice over Internet Protocol (VOIP) and for packet-switched data services to the remote device 530A or 530B. The cellular capable secondary wireless device 520 (and a user thereof) can be mobile, e.g., the user of the cellular capable secondary wireless device 520 can move and thereby change position with respect to the primary wireless device 510, which can provide relayed connections that use shorter distance local connections as illustrated in FIG. 52A. When within proximity (within local wireless connectivity range) of the primary wireless device 510, the cellular capable secondary wireless device 520 can use local connections, e.g., WPAN connections 504 and/or WLAN connections 506, to the primary wireless device 510. When not within proximity (out of local wireless connectivity range) of the primary wireless device 510, the cellular capable secondary wireless device 520 may communicate via a WWAN connection 508, when permitted to establish the WWAN connection 508. With a direct WWAN connection 508, the cellular capable secondary wireless device 520, with limited hardware capability for cellular connections to cellular wireless networks, can be required to be configured for one of the subscriptions available, e.g., a user of the cellular capable secondary wireless device 520 can be required to select a particular eSIM 208 of multiple eSIMs 208 stored in an eUICC 108 of the cellular capable secondary wireless device 520 to use when the cellular capable secondary wireless device 520 is not within local wireless range of the primary wireless device 510. As such, the cellular capable secondary wireless device 520 can be restricted from mirroring a multiple SIM/eSIM capability of the primary wireless device 510. To overcome this limitation, as described herein, the cellular capable secondary wireless device 520 can be re-configured via software and/or firmware to support at least one virtual cellular wireless connection for a SIM/eSIM via an actual cellular wireless connection of another SIM/eSIM.

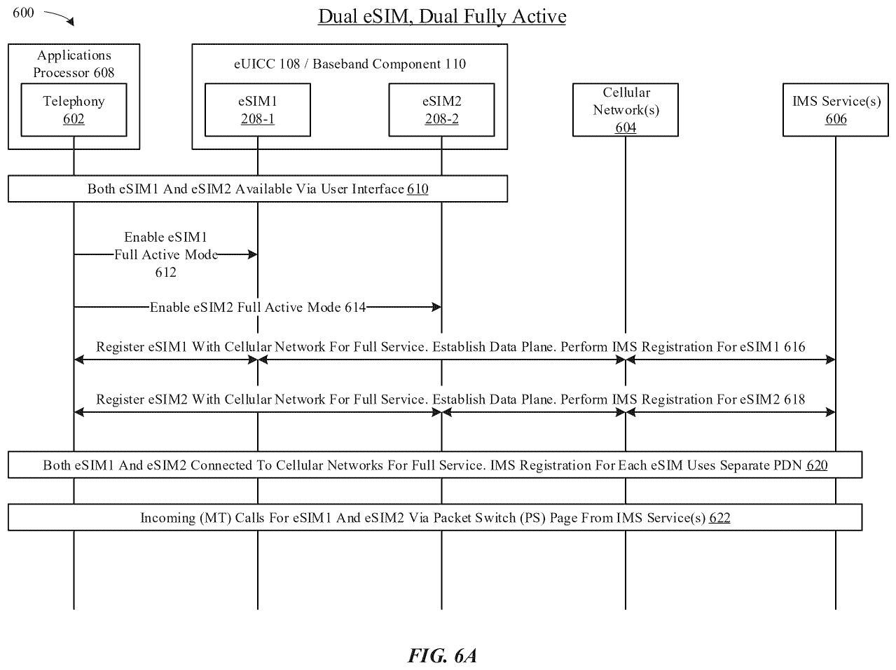

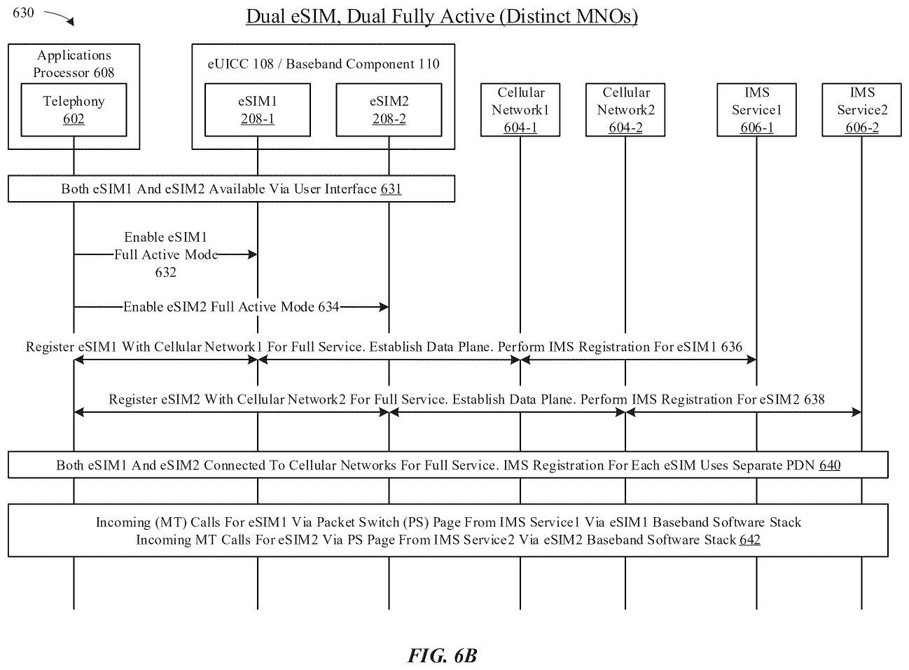

FIG. 6A illustrates a flow diagram 600 of a dual-eSIM wireless device 102 with a dual fully active capability. The wireless device 102 includes an applications processor 608 that executes code for one or more applications of the wireless device 102, which can include an operating system that provides a cellular telephony service via a telephony module 602. The eUICC 108 of the wireless device 102 further includes two separate eSIMs 208-1, 208-2 that provide access to cellular wireless services of one or more cellular wireless networks 604. In some embodiments, the first eSIM 208-1 and the second eSIM 208-2 are associated with a common MNO 114 and provide access to cellular wireless services under different subscriptions of a common cellular wireless network 604. In some embodiments, the first eSIM 208-1 and the second eSIM 208-2 are associated with different MNOs 114 and each provide access to cellular wireless services under different subscriptions of distinct cellular wireless networks 604. In some embodiments, the dual-eSIM wireless device 102 includes wireless circuitry 308 that allows for simultaneous connection to multiple cellular wireless networks 604 simultaneously. In some embodiments, the dual-eSIM wireless device 102 includes wireless circuitry 308 that allows for switching between a connection to a first cellular wireless network 604 and a second cellular wireless network 604. At 610, both subscriptions for both the first eSIM 208-1 and for the second eSIM 208-2 can each be indicated as available for access to cellular wireless service via a user interface of the dual-eSIM wireless device 102. At 612, the telephony module 602 of the applications processor 608 can enable the first eSIM 208-1 to a fully active mode on the eUICC 108 of the dual-eSIM wireless device 102. At 614, the telephony module 602 of the applications processor 608 can enable the second eSIM 208-2 to a fully active mode on the eUICC 108 of the dual-eSIM wireless device 102. At 616, the telephony module 602 can cause the dual-eSIM wireless device 102 to register the first eSIM 208-1 for full service with a first cellular wireless network 604. The baseband component 110 can establish a data plane connection via a cellular wireless connection with the first cellular wireless network 604 and perform an IMS registration for the first eSIM 208-1 with an IMS service 606 of the first cellular wireless network 604. At 618, the telephony module 602 can cause the dual-eSIM wireless device 102 to register the second eSIM 208-2 for full service with a second cellular wireless network 604. The baseband component 110 can establish a data plane connection via a cellular wireless connection with the second cellular wireless network 604 and perform an IMS registration for the second eSIM 208-1 with an IMS service 606 of the second cellular wireless network 604. (As discussed hereinabove, the first and second wireless networks 604 can be the same cellular wireless network 604 in some embodiments and can be separate cellular wireless networks 604 in some embodiments). At 620, the dual-eSIM wireless device 102 can be connected for full service to one or more cellular wireless networks 604 via the first eSIM 208-1 and via the second eSIM 208-2, where IMS registration for each of the first eSIM 208-1 and the second eSIM 208-2 can use a separate PDN. At 622, incoming mobile-terminated (MT) calls for the first eSIM 208-1 and for the second eSIM 208-2 can be indicated via packet switch (PS) pages from the one or more IMS services 606. In some embodiments, the first eSIM 208-1 and the second eSIM 208-2 are associated with a common MNO 114 with a common cellular network 604 and a common IMS service 606. In some embodiments, the first eSIM 208-1 and the second eSIM 208-2 are associated with separate MNOs 114 with separate cellular networks 604 and a common IMS service 606. In some embodiments, the first eSIM 208-1 and the second eSIM 208-2 are associated with separate MNOs 114 with separate cellular networks 604 and separate IMS services 606.

FIG. 6B illustrates a flow diagram 630 for a specific example where a dual-eSIM wireless device 102 has a dual fully active capability to communicate with two distinct cellular wireless networks 604-1, 604-2 using two distinct eSIMs 208-1, 208-2. The first eSIM 208-1 of the dual-eSIM wireless device 102 provides for access to the first cellular wireless network 604-1 associated with a first MNO 114-1, while the second eSIM 208-2 provides for access to the second cellular wireless network 604-2 associated with a second MNO 114-2. In addition, each cellular wireless network 604-1, 604-2 maintains their own distinct IMS services 606-1, 606-2. In some embodiments, the dual-eSIM wireless device 102 can include wireless circuitry 308 that allows for simultaneous connection to the first and second cellular wireless networks 604-1, 604-2 simultaneously. In some embodiments, the dual-eSIM wireless device 102 includes wireless circuitry 308 that allows for switching between a connection to the first cellular wireless network 604-1 and the second cellular wireless network 604-2. At 631, both subscriptions for both the first eSIM 208-1 and for the second eSIM 208-2 can each be indicated as available for access to cellular wireless service via a user interface of the dual-eSIM wireless device 102. At 632, the telephony module 602 of the applications processor 608 can enable the first eSIM 208-1 to a fully active mode on the eUICC 108 of the dual-eSIM wireless device 102. At 634, the telephony module 602 of the applications processor 608 can enable the second eSIM 208-2 to a fully active mode on the eUICC 108 of the dual-eSIM wireless device 102. At 636, the telephony module 602 can cause the dual-eSIM wireless device 102 to register the first eSIM 208-1 for full service with the first cellular wireless network 604-1. The baseband component 110 can establish a data plane connection via a cellular wireless connection with the first cellular wireless network 604-1 and perform an IMS registration for the first eSIM 208-1 with a first IMS service 606-1 of the first cellular wireless network 604-1. At 638, the telephony module 602 can cause the dual-eSIM wireless device 102 to register the second eSIM 208-2 for full service with a second cellular wireless network 604-2. The baseband component 110 can establish a data plane connection via a cellular wireless connection with the second cellular wireless network 604-2 and perform an IMS registration for the second eSIM 208-1 with an IMS service 606-2 of the second cellular wireless network 604-2. At 640, the dual-eSIM wireless device 102 can be connected for full service to the two cellular wireless networks 604-1, 604-1 via the first eSIM 208-1 and via the second eSIM 208-2 respectively, where IMS registration for each of the first eSIM 208-1 and the second eSIM 208-2 can use a separate PDN. At 642, incoming mobile-terminated (MT) calls for the first eSIM 208-1 and for the second eSIM 208-2 can be indicated individually via separate packet switch (PS) pages from the two IMS services 606-1, 606-2.

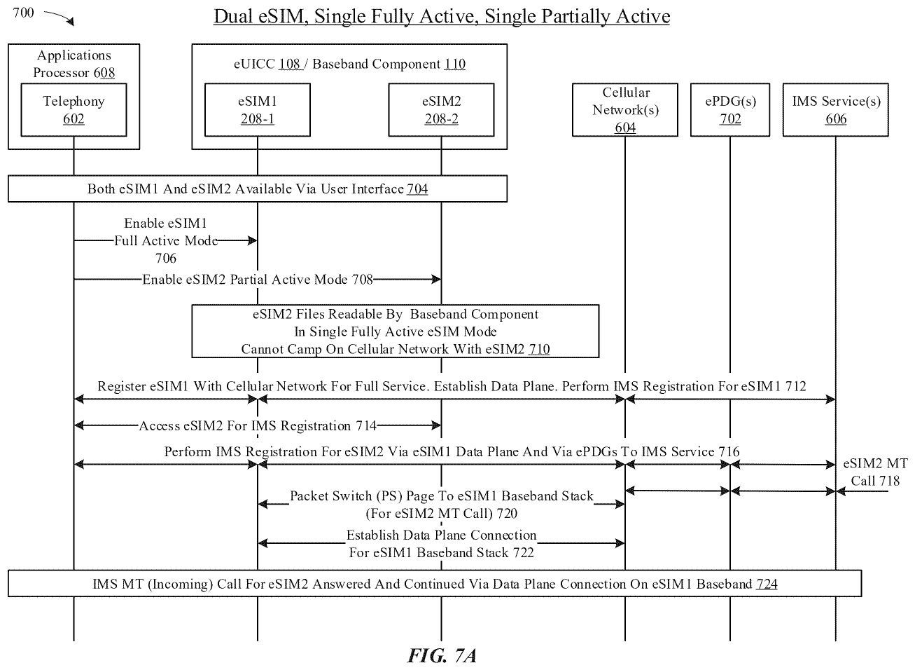

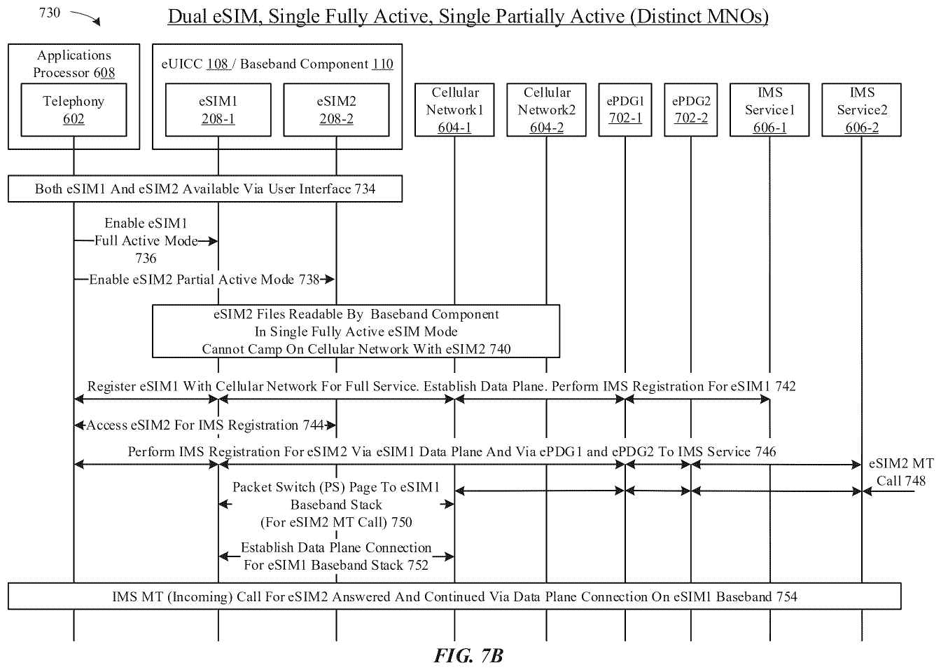

FIG. 7A illustrates a flow diagram 700 of a dual-eSIM wireless device 102 with a capability to support a first eSIM 208-1 in a fully active state, and a second eSIM 208-2 in a partially active state. The eUICC 108 of the wireless device 102 further includes two separate eSIMs 208-1, 208-2 that provide access to cellular wireless services of one or more cellular wireless networks 604. In some embodiments, the first eSIM 208-1 and the second eSIM 208-2 are associated with a common MNO 114 and provide access to cellular wireless services under different subscriptions of a common cellular wireless network 604. In some embodiments, the first eSIM 208-1 and the second eSIM 208-2 are associated with different MNOs 114 and each provide access to cellular wireless services under different subscriptions of distinct cellular wireless networks 604. The dual-eSIM wireless device 102 can emulate a dual standby capability by tunneling data for the second eSIM 208-2 via a cellular wireless data connection via the first eSIM 208-1. At 704, both subscriptions for both the first eSIM 208-1 and for the second eSIM 208-2 can each be indicated as available for access to cellular wireless service via a user interface of the dual-eSIM wireless device 102. In some embodiments, one or more specific services for the first eSIM 208-1 and/or the second eSIM 208-2 can be indicated as available by the user interface of the dual-eSIM wireless device. In some embodiments, the second eSIM 208-2 is indicated as available for a select set of services. At 706, the telephony module 602 of the applications processor 608 can enable the first eSIM 208-1 to a fully active mode on the eUICC 108 of the dual-eSIM wireless device 102. At 708, the telephony module 602 of the applications processor 608 can enable the second eSIM 208-1 in a partially active mode. In some embodiments, the partially active mode includes a logical connection between the baseband component 110 and the eUICC 108 for the second eSIM 208-1. In some embodiments, the partially active mode for an eSIM 208 allows select files and/or processes of an eSIM 208 in a disabled state to be accessed by the baseband component 110. At 710, one or more files of the second eSIM 208-2 (in a partially active mode) are readable by the baseband component 110 of the dual-eSIM wireless device 102 operating in a single fully active eSIM mode, where the baseband component 110 (and the dual-eSIM wireless device 102) can camp on a cellular wireless network via the first eSIM 208-1 but cannot camp on a cellular wireless network via the second eSIM 208-2. At 712, the telephony module 602 can cause the dual-eSIM wireless device 102 to register the first eSIM 208-1 for full service with a first cellular wireless network 604. The baseband component 110 can establish a data plane connection via a cellular wireless connection with the first cellular wireless network 604 and perform an IMS registration for the first eSIM 208-1 with an IMS service 606 of the first cellular wireless network 604. At 714, the telephony module 602 can cause the baseband component 110 to access one or more files and/or processes of the second eSIM 208-2 in order to perform an IMS registration procedure for the second eSIM 208-2. In some embodiments, the one or more files and/or processes of the second eSIM 208-2 are used for an authentication procedure, such as data and/or messages for an extensible authentication protocol-authentication and key agreement (EAP-AKA) procedure associated with the IMS registration procedure. At 716, the telephony module 602 causes the baseband component 110 to perform an IMS registration procedure for the second eSIM 208-2 with an IMS service 606 via the data plane connection established via the first eSIM 208-1 and via an evolved packet data network gateway (ePDG) 702 associated with the cellular wireless network associated with the second eSIM 208-2. At 718, the IMS service 606 for the second cellular wireless network associated with the second eSIM 208-2 receives an indication of an incoming mobile terminated (MT) voice call for the second eSIM 208-2. The IMS service 606 signals via the ePDG 702 to the cellular wireless network 604 associated with the first eSIM 208-1 of the incoming MT voice call for the second eSIM 208-2. At 720, the cellular wireless network 604 associated with the first eSIM 208-1 sends a packet switch (PS) page indication to the baseband software stack associated with the first eSIM 208-1, where the PS page indication is for the incoming MT voice call for the second eSIM 208-2. At 722, the baseband component 110 establishes a data plane connection with the cellular wireless network 604 associated with the first eSIM 208-1 (if not already established), where this data plane connection established via the first eSIM 208-1 can transport tunneled data for the second eSIM 208-2. At 724, the incoming MT voice call for the second eSIM 208-2 is answered and continued via the data plane connection of the baseband software stack of the first eSIM 208-1. While FIG. 7 illustrates an exemplary embodiment in which a dual-eSIM wireless device 102 can support a single active eSIM 208-1 and an additional partially active eSIM 208-2, the same ideas can be extended to include multiple partially active eSIMs 208 to be available via the single active eSIM 208-1. In general, for each eSIM 208 of a wireless device 102 that can be configured in a fully active mode, the wireless device 102, in some embodiments, can configured one or more additional eSIMs 208 in a partially active mode, where data connections of the fully active mode eSIMs 208 are used to carry data for the partially active mode eSIMs 208. In some embodiments, the first eSIM 208-1 and the second eSIM 208-2 are associated with separate MNOs 114 with separate cellular networks 604 and a common IMS service 606. In some embodiments, the first eSIM 208-1 and the second eSIM 208-2 are associated with separate MNOs 114 with separate cellular networks 604 and separate IMS services 606.

FIG. 7B illustrates a flow diagram 730 of a dual-SIM wireless device 102 with a capability to support a first eSIM 208-1 in a fully active state, and a second eSIM 208-2 in a partially active state. The eUICC 108 of the wireless device 102 further includes two separate eSIMs 208-1, 208-2 that provide access to cellular wireless services of a first cellular wireless network 604-1 and a second cellular wireless network 604-2 respectively. The first eSIM 208-1 and the second eSIM 208-2 can be associated with different MNOs 114 and each provide access to cellular wireless services under different subscriptions of the distinct cellular wireless networks 604-1, 604-2. The dual-eSIM wireless device 102 can emulate a dual standby capability (to provide a virtual dual standby capability for both subscriptions) by tunneling data for the second eSIM 208-2 from the second cellular wireless network 604-2 via a cellular wireless data connection established with the first cellular wireless network 604-1 via the first eSIM 208-1. At 734, both subscriptions for both the first eSIM 208-1 and for the second eSIM 208-2 can each be indicated as available for access to cellular wireless service via a user interface of the dual-eSIM wireless device 102. In some embodiments, one or more specific services for the first eSIM 208-1 and/or the second eSIM 208-2 can be indicated as available by the user interface of the dual-eSIM wireless device. In some embodiments, the second eSIM 208-2 is indicated as available for a select set of services. At 736, the telephony module 602 of the applications processor 608 can enable the first eSIM 208-1 to a fully active mode on the eUICC 108 of the dual-eSIM wireless device 102. At 738, the telephony module 602 of the applications processor 608 can enable the second eSIM 208-1 in a partially active mode. In some embodiments, the partially active mode includes a logical connection between the baseband component 110 and the eUICC 108 for the second eSIM 208-1. In some embodiments, the partially active mode for an eSIM 208 allows select files and/or processes of an eSIM 208 in a disabled state to be accessed by the baseband component 110. At 740, one or more files of the second eSIM 208-2 (in a partially active mode) are readable by the baseband component 110 of the dual-eSIM wireless device 102 operating in a single fully active eSIM mode, where the baseband component 110 (and the dual-eSIM wireless device 102) can camp on a cellular wireless network via the first eSIM 208-1 but cannot camp on a cellular wireless network via the second eSIM 208-2. At 742, the telephony module 602 can cause the dual-eSIM wireless device 102 to register the first eSIM 208-1 for full service with a first cellular wireless network 604. The baseband component 110 can establish a data plane connection via a cellular wireless connection with the first cellular wireless network 604-1 and perform an IMS registration for the first eSIM 208-1 with an IMS service 606-1 of the first cellular wireless network 604-1. At 744, the telephony module 602 can cause the baseband component 110 to access one or more files and/or processes of the second eSIM 208-2 in order to perform an IMS registration procedure for the second eSIM 208-2. In some embodiments, the one or more files and/or processes of the second eSIM 208-2 are used for an authentication procedure, such as data and/or messages for an extensible authentication protocol-authentication and key agreement (EAP-AKA) procedure associated with the IMS registration procedure. At 746, the telephony module 602 causes the baseband component 110 to perform an IMS registration procedure for the second eSIM 208-2 with an IMS service 606-2 of the second cellular wireless network 604-2 via the data plane connection established via the first eSIM 208-1 and via a first evolved packet data network gateway (ePDG) 702-1 of the first cellular wireless network 604-1 to a second ePDG 702-2 of the second cellular wireless network 604-2 associated with the second eSIM 208-2. At 748, the IMS service 606-2 of the second cellular wireless network 604-2 associated with the second eSIM 208-2 receives an indication of an incoming mobile terminated (MT) voice call for the second eSIM 208-2. The IMS service 606-2 of the second cellular wireless network 604-2 signals via the ePDG 702-2 and then via the ePDG 702-1 to the first cellular wireless network 604-1 associated with the first eSIM 208-1 of the incoming MT voice call for the second eSIM 208-2. At 750, the first cellular wireless network 604-1 associated with the first eSIM 208-1 sends a packet switch (PS) page indication to the baseband software stack associated with the first eSIM 208-1, where the PS page indication is for the incoming MT voice call for the second eSIM 208-2. At 752, the baseband component 110 establishes a data plane connection with the first cellular wireless network 604-1 (if not already established), where this data plane connection established via the first eSIM 208-1 can transport tunneled data for the second eSIM 208-2. At 754, the incoming MT voice call for the second eSIM 208-2 is answered and continued via the data plane connection of the baseband software stack of the first eSIM 208-1.

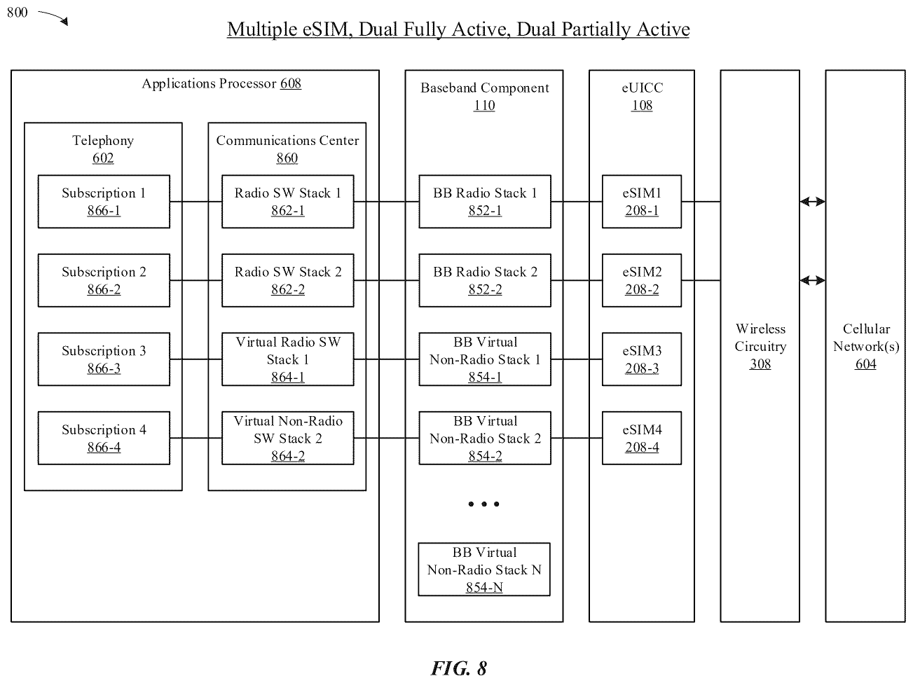

FIG. 8 illustrates a block diagram 800 for a multi-eSIM wireless device 102 in which two eSIMs 208-1, 208-2 are placed in a fully active mode, and an additional two eSIMs 208-3, 208-4 are placed in a partially active mode. An eSIM 208 in a fully active mode can be used for establishing cellular wireless connections directly with a cellular wireless network and for accessing services of the cellular wireless network. The eSIM 208 in the fully active mode can be powered up and can include a baseband radio stack that is connected to the eUICC 108 via one or more logical connections. An eSIM 208 in a partially active mode can be accessed to obtain data and/or messages required for procedures to register for an IMS service of a cellular wireless network but cannot be used (in the partially active mode) for establishing direct connections with a cellular wireless network. Instead, data for access to select cellular wireless services of the eSIM 208 in the partially active mode are required to be encapsulated and transported by a data connection of another eSIM 208 in a fully active mode. The eSIM 208 in the partially active mode can be powered up and can include a baseband virtual non-radio stack that is connected to the eUICC 108 via one or more logical connections. As shown in the diagram 800 of FIG. 8, the baseband component 110 includes a first baseband radio (software) stack 852-1 that is connected to a first radio software stack 862-1 of a communications center module 860 of an applications processor 608 of the multi-eSIM wireless device 102. The first baseband radio (software) stack 852-1 of the baseband component 110 is also connected via one or more logical connections to a first eSIM 208-1 in a fully active mode. The baseband component 110 can establish a cellular wireless radio connection via wireless circuitry 308 of the multi-eSIM wireless device 102 to a cellular wireless network 604, e.g., via an access network portion of the cellular wireless network 604, using credentials of the first eSIM 208-1. The first radio software stack 862-1 of the communication center module 860 can also be connected to a first subscription 866-1 of a telephony module 602 of the applications processor 608, where the first subscription 866-1 is associated with the first eSIM 208-1 and availability of subscriptions can be indicated via a user interface of the multi-eSIM wireless device 102. As further shown in the diagram 800 of FIG. 8, the baseband component 110 includes a second baseband radio (software) stack 852-2 that is connected to a second radio software stack 862-2 of the communications center module 860 of the applications processor 608 of the multi-eSIM wireless device 102. The second baseband radio (software) stack 852-2 of the baseband component 110 is also connected via one or more logical connections to a second eSIM 208-2 in a fully active mode. The baseband component 110 can establish a cellular wireless radio connection via wireless circuitry 308 of the multi-eSIM wireless device 102 to a cellular wireless network 604, e.g., via an access network portion of the cellular wireless network 604, using credentials of the second eSIM 208-2. The second radio software stack 862-2 of the communication center module 860 can also be connected to a second subscription 866-2 of the telephony module 602 of the applications processor 608, where the second subscription 866-2 is associated with the second eSIM 208-2.

As indicated, the multi-eSIM wireless device 102 of FIG. 8 can enable and place in a fully active mode two distinct eSIMs 208-1, 208-2 for access to cellular wireless services of the two distinct eSIMs 208-1, 208-2. Furthermore, the multi-eSIM wireless device 102 can further enable access to cellular wireless services of two additional eSIMs 208-3, 208-4 indirectly by enabling and placing the two additional eSIMs 208-3, 208-4 in a partially active mode. The baseband component 110 can be restricted from establishing direct cellular wireless radio connections via wireless circuitry 308 of the multi-eSIM wireless device 102 to access network portions of one or more cellular wireless networks using credentials of the third eSIM 208-3 and the fourth eSIM 208-4. Instead, the multi-eSIM wireless device 102 can provide access to select cellular wireless services of cellular wireless networks associated with the third and fourth eSIMs 208-3, 208-4 via tunneled data connections over direct cellular wireless connections of one or both of the first and second eSIMs 208-1, 208-2. The baseband component 110 includes a first baseband virtual non-radio (software) stack 854-1 that is connected to a first virtual radio software stack 864-1 of the communications center module 860 of the applications processor 608 of the multi-eSIM wireless device 102. The first baseband virtual non-radio (software) stack 854-1 of the baseband component 110 is also connected via one or more logical connections to the third eSIM 208-3 in a partially active mode. The baseband component 110 cannot establish a cellular wireless connection via the third eSIM 208-3 in the partially active mode; however, the baseband component 110 can access one or more files and or processes of the third eSIM 208-3, such as to perform an authentication procedure required to register the third eSIM 208-3 with an IMS service. The first virtual radio software stack 864-1 of the baseband component 110 is also connected to a third subscription 866-3 of the telephony module 602 of the applications processor 608, where the third subscription 866-3 is associated with the third eSIM 208-3. Similarly, a second broadband virtual non-radio (software) stack 854-2 in the baseband component 110 is connected logically to the fourth eSIM 208-4 and to a virtual non-radio software stack 864-2 in the communications center module 860, which in turn connects to a fourth subscription 866-4 associated with the fourth eSIM 208-4. The baseband component 110 cannot establish a cellular wireless connection via the fourth eSIM 208-4 in the partially active mode; however, the baseband component 110 can access one or more files and or processes of the fourth eSIM 208-4, such as to perform an authentication procedure required to register the fourth eSIM 208-4 with an IMS service. In some embodiments, the number of baseband virtual non-radio (software) stacks available in the baseband component 110 can be effectively unbounded. The first and second eSIMs 208-1, 208-2 in the fully active mode can be used to transport data packets for select cellular wireless services, e.g., data messaging, video calls, voice over IP calls, etc., for the third and fourth eSIMs 208-3, 208-4. In general, for each eSIM 208 of a wireless device 102 that can be configured in a fully active mode, the wireless device 102, in some embodiments, can configured one or more additional eSIMs 208 in a partially active mode, where data connections of the fully active mode eSIMs 208 are used to carry data for the partially active mode eSIMs 208.

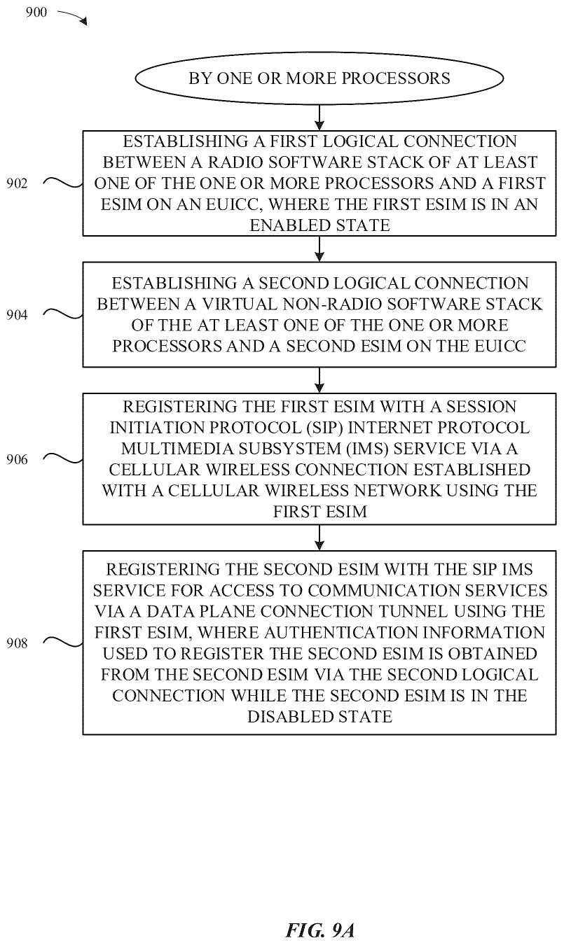

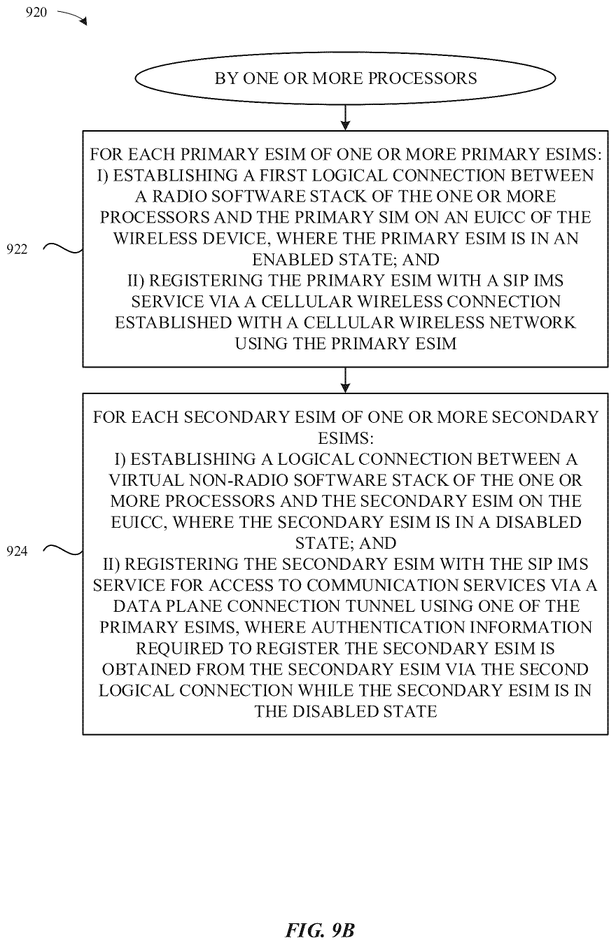

FIG. 9A illustrates a flow chart 900 of a representative method to enable virtual connectivity for a second eSIM 208 via a cellular wireless capability of a first eSIM 208. At 902, the method includes establishing a first logical connection between a radio software stack of at least one of one or more processors and the first eSIM 208 on an eUICC 108, wherein the first eSIM 208 is in an enabled state. At 904, the method further includes establishing a second logical connection between a virtual non-radio software stack of the at least one of the one or more processors and the second eSIM 208 on the eUICC 108, where the second eSIM 208 is in a disabled state. At 906, the method further includes registering the first eSIM 208 with a SIP IMS service via a cellular wireless connection established with a cellular wireless network using the first eSIM 208. At 908, the method further includes registering the second eSIM 208 with the SIP IMS service for access to communication services via a data plane connection tunnel using the first eSIM 208, where authentication information used to register the second eSIM 208 is obtained from the second eSIM 208 via the second logical connection while the second eSIM 208 is in the disabled state.

In some embodiments, the authentication information includes data and/or messages for an EAP-AKA procedure. In some embodiments, the method further includes restricting establishment of a cellular wireless connection directly to a cellular wireless network using the second eSIM 208 while the second eSIM 208 is in the disabled state. In some embodiments, the method further includes restricting access to select files and/or processes of the second eSIM 208 while the second eSIM 208 is in the disabled state. In some embodiments, the method further includes: i) receiving a packet switch (PS) page addressed to the first eSIM 208 indicating an incoming mobile terminated (MT) call for the second eSIM 208, ii) establishing a data plane connection via the first eSIM 208 to the cellular wireless network, and iii) answering and continuing the MT call for the second eSIM 208 via the data plane connection of the first eSIM 208. In some embodiments, the method further includes establishing the data plane connection tunnel for the second eSIM 208 via the data plane connection of the first eSIM 208, where the MT call for the second eSIM 208 is conducted via the data plane connection tunnel. In some embodiments, the data plane connection tunnel connects the wireless device 102 via a packet data network gateway of the cellular wireless network associated with the first eSIM 208 to an evolved packet data network gateway of a cellular wireless network associated with the second eSIM 208. In some embodiments, the method further includes: i) establishing a first radio software stack for the first eSIM 208, and ii) establishing a first virtual non-radio software stack for the second eSIM 208. In some embodiments, the first radio software stack and the first virtual non-radio software stack are instantiated by a first processor of the one or more processors, e.g., by a baseband processor. In some embodiments, the method further includes: i) establishing a second radio software stack for the first eSIM 208 connected with the first radio software stack, and ii) establishing a second virtual non-radio software stack for the second eSIM 208 connected with the first virtual non-radio software stack. In some embodiments, the second radio software stack and the second virtual non-radio software stack are instantiated by a second processor of the one or more processors, e.g., by an applications processor.

FIG. 9B illustrates a flow chart 920 of an exemplary method to enable virtual connectivity for one or more secondary eSIMs 208 via a cellular wireless capability of one or more primary eSIMs 208 of a wireless device 102. At 922, the one or more processors perform the following actions for each primary eSIM 208 of the one or more primary eSIMs 208 of the wireless device 102: i) establishing a first logical connection between a radio software stack of the one or more processors and the primary eSIM 208 on an eUICC 108 of the wireless device 102, where the primary eSIM 208 is in an enabled state, and ii) registering the primary eSIM 208 with a SIP IMS service 606 via a cellular wireless connection established with a cellular wireless network 604 using the primary eSIM 208. At 924, the one or more processors perform the following actions for each secondary eSIM 208 of the one or more secondary eSIMs 208 of the wireless device: i) establishing a second logical connection between a virtual non-radio software stack of the one or more processors and the secondary eSIM 208 on the eUICC 108, where the secondary eSIM 208 is in a disabled state, and ii) registering the secondary eSIM with an associated SIP IMS service 606 for access to communication services via a data plane connection tunnel using one of the primary eSIMs 208, where authentication information required to register the secondary eSIM 208 is obtained from the secondary eSIM 208 via the second logical connection while the secondary eSIM 208 is in the disabled state. In some embodiments, the one or more processors of the wireless device 102 are restricted from establishing a cellular wireless connection directly to one or more cellular wireless networks 604 using secondary eSIMs 208 while the secondary eSIMs 208 are in the disabled state.

### Representative Exemplary Apparatus

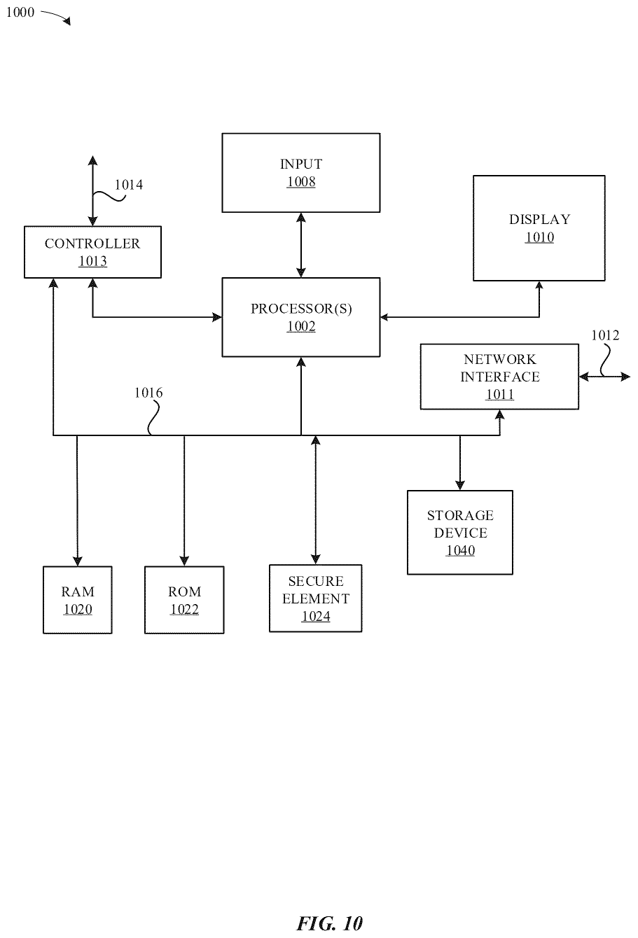

FIG. 10 illustrates in block diagram format an exemplary computing device 1000 that can be used to implement the various components and techniques described herein, according to some embodiments. In particular, the detailed view of the exemplary computing device 1000 illustrates various components that can be included in the wireless device 102. As shown in FIG. 10, the computing device 1000 can include one or more processors 1002 that represent microprocessors or controllers for controlling the overall operation of computing device 1000. In some embodiments, the computing device 1000 can also include a user input device 1008 that allows a user of the computing device 1000 to interact with the computing device 1000. For example, in some embodiments, the user input device 1008 can take a variety of forms, such as a button, keypad, dial, touch screen, audio input interface, visual/image capture input interface, input in the form of sensor data, etc. In some embodiments, the computing device 1000 can include a display 1010 (screen display) that can be controlled by the processor(s) 1002 to display information to the user (for example, information relating to incoming, outgoing, or active communication sessions). A data bus 1016 can facilitate data transfer between at least a storage device 1040, the processor(s) 1002, and a controller 1013. The controller 1013 can be used to interface with and control different equipment through an equipment control bus 1014. The computing device 1000 can also include a network/bus interface 1011 that couples to a data link 1012. In the case of a wireless connection, the network/bus interface 1011 can include wireless circuitry, such as a wireless transceiver and/or baseband component. The computing device 1000 can also include a secure element 1024. The secure element 1024 can include an eUICC 108, an iUICC, and/or one or more UICCs 118.

The computing device 1000 also includes a storage device 1040, which can include a single storage or a plurality of storages (e.g., hard drives and/or solid-state drives), and includes a storage management module that manages one or more partitions within the storage device 1040. In some embodiments, storage device 1040 can include flash memory, semiconductor (solid state) memory or the like. The computing device 1000 can also include a Random-Access Memory (RAM) 1020 and a Read-Only Memory (ROM) 1022. The ROM 1022 can store programs, utilities or processes to be executed in a non-volatile manner. The RAM 1020 can provide volatile data storage, and stores instructions related to the operation of the computing device 1000.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to enable virtual connectivity for a second electronic subscriber identity module (eSIM) via a cellular wireless capability of a first eSIM, the method comprising:
by one or more processors:
establishing a first logical connection between a radio software stack of at least one of the one or more processors and the first eSIM on an embedded universal integrated circuit card (eUICC), wherein the first eSIM is in an enabled state;
establishing a second logical connection between a virtual non-radio software stack of the at least one of the one or more processors and the second eSIM on the eUICC, wherein the second eSIM is in a disabled state;
registering the first eSIM with a session initiation protocol (SIP) internet protocol multimedia subsystem (IMS) service via a cellular wireless connection established with a cellular wireless network using the first eSIM; and
registering the second eSIM with the SIP IMS service for access to communication services via a data plane connection tunnel using the first eSIM, wherein authentication information used to register the second eSIM is obtained from the second eSIM via the second logical connection while the second eSIM is in the disabled state.

2. The method of claim 1, wherein the authentication information comprises data and/or messages for an extensible authentication protocol-authentication and key agreement (EAP-AKA) procedure.

3. The method of claim 1, further comprising:
restricted establishment of a cellular wireless connection directly to a cellular wireless network using the second eSIM while the second eSIM is in the disabled state.

4. The method of claim 1, further comprising:
restricting access to select files and/or processes of the second eSIM while the second eSIM is in the disabled state.

5. The method of claim 1, further comprising:
receiving a packet switch (PS) page addressed to the first eSIM indicating an incoming mobile terminated (MT) call for the second eSIM;
establishing a data plane connection via the first eSIM to the cellular wireless network; and
answering and continuing the MT call for the second eSIM via the data plane connection of the first eSIM.

6. The method of claim 5, further comprising:
establishing the data plane connection tunnel for the second eSIM via the data plane connection of the first eSIM,
wherein the MT call for the second eSIM is conducted via the data plane connection tunnel.

7. The method of claim 1, wherein the data plane connection tunnel connects via a packet data network gateway of the cellular wireless network associated with the first eSIM to an evolved packet data network gateway of a cellular wireless network associated with the second eSIM.

8. The method of claim 1, further comprising:
by a first processor of the one or more processors:
establishing a first radio software stack for the first eSIM; and
establishing a first virtual non-radio software stack for the second eSIM.

9. The method of claim 8, further comprising:
by a second processor of the one or more processors:
establishing a second radio software stack for the first eSIM associated with the first radio software stack; and
establishing a second virtual non-radio software stack for the second eSIM associated with the first virtual non-radio software stack.

10. An apparatus comprising at least one processor coupled to memory, the at least one processor configured to:
establish a first logical connection between a radio software stack associated with the at least one processor and a first electronic subscriber identity module (eSIM) on an embedded universal integrated circuit card (eUICC), wherein the first eSIM is in an enabled state;
establish a second logical connection between a virtual non-radio software stack associated with the at least one processor and a second eSIM on the eUICC, wherein the second eSIM is in a disabled state;
register the first eSIM with a session initiation protocol (SIP) internet protocol multimedia subsystem (IMS) service via a cellular wireless connection established with a cellular wireless network using the first eSIM; and
register the second eSIM with the SIP IMS service for access to communication services via a data plane connection tunnel using the first eSIM, wherein authentication information used to register the second eSIM is obtained from the second eSIM via the second logical connection while the second eSIM is in the disabled state.

11. The apparatus of claim 10, wherein the authentication information comprises data and/or messages for an extensible authentication protocol-authentication and key agreement (EAP-AKA) procedure.

12. The apparatus of claim 10, wherein the at least one processor is restricted from establishing a cellular wireless connection directly to a cellular wireless network using the second eSIM while the second eSIM is in the disabled state.

13. The apparatus of claim 10, wherein the at least one processor is restricted to access select files and/or processes of the second eSIM while the second eSIM is in the disabled state.

14. The apparatus of claim 10, wherein the at least one processor is further configured to:
receive a packet switch (PS) page addressed to the first eSIM indicating an incoming mobile terminated (MT) call for the second eSIM;
establish a data plane connection via the first eSIM to the cellular wireless network; and
answer and continue the MT call for the second eSIM via the data plane connection of the first eSIM.

15. The apparatus of claim 14, wherein the at least one processor is further configured to:
establish the data plane connection tunnel for the second eSIM via the data plane connection of the first eSIM,
wherein the MT call for the second eSIM is conducted via the data plane connection tunnel.

16. The apparatus of claim 10, wherein the data plane connection tunnel connects via a packet data network gateway of the cellular wireless network associated with the first eSIM to an evolved packet data network gateway of a cellular wireless network associated with the second eSIM.

17. The apparatus of claim 10, wherein the at least one processor comprises a baseband processor configured to:
establish a first radio software stack for the first eSIM; and
establish a first virtual non-radio software stack for the second eSIM.

18. The apparatus of claim 17, wherein the at least one processor further comprises an applications processor configured to:
establish a second radio software stack for the first eSIM associated with the first radio software stack; and
establish a second virtual non-radio software stack for the second eSIM associated with the first virtual non-radio software stack.

19. A method to enable virtual connectivity for one or more secondary electronic subscriber identity modules (eSIMs) via cellular wireless capabilities of one or more primary eSIMs of a wireless device, the method comprising:
by at least one of one or more processors:
for each primary eSIM of the one or more primary eSIMs:
establishing a first logical connection between a radio software stack of the one or more processors and the primary eSIM on an embedded universal integrated circuit card (eUICC) of the wireless device, wherein the primary eSIM is in an enabled state; and
registering the primary eSIM with a session initiation protocol (SIP) internet protocol multimedia subsystem (IMS) service via a cellular wireless connection established with a cellular wireless network using the primary eSIM; and
for each secondary eSIM of the one or more secondary eSIMs:
establishing a second logical connection between a virtual non-radio software stack of the one or more processors and the secondary eSIM on the eUICC, wherein the secondary eSIM is in a disabled state; and
registering the secondary eSIM with an associated SIP IMS service for access to communication services via a data plane connection tunnel using one of the primary eSIMs, wherein authentication information required to register the secondary eSIM is obtained from the secondary eSIM via the second logical connection while the secondary eSIM is in the disabled state.

20. The method of claim 19, further comprising:
restricting establishment of a cellular wireless connection directly to one or more cellular wireless networks using secondary eSIMs while the secondary eSIMs are in the disabled state.
